(19) United States
(12) Patent Application Publication
(10) Pub. No.: US 2012/0077882 A1
(43) Pub. Date: Mar. 29, 2012

(54) ANTIBACTERIAL AGENT-COMPRISING POWDERS AND METHODS FOR MANUFACTURING THE SAME

(75) Inventors: Chris Luciow, Scottsdale, AZ (US); Terannie Vazquez Alvarez, Gilbert, AZ (US); Bruce R. Cox, Scottsdale, AZ (US); Catherine Schmit, Glendale, AZ (US)

(73) Assignee: The Dial Corporation, Scottsdale, AZ (US)

(21) Appl. No.: 12/890,027

(22) Filed: Sep. 24, 2010

(51) Int. Cl. A01N 33/12; A01P 1/00; A01N 31/02

(52) U.S. Cl. 514/643; 514/724

(57) ABSTRACT

Skin and surface sanitizers and methods for forming skin and surface sanitizers are provided. In one embodiment, a surface sanitizer is formed of a plurality of dry particles. Each dry particle comprises a liquid comprising an antibacterial agent and a dry particulates coating surrounding the liquid. The liquid is present in an amount of from about 10 to about 90 wt. % of each dry particle. The surface sanitizer has a germ kill effectiveness of at least 50%.

### FIELD OF THE INVENTION

The present invention generally relates to sanitizing products and methods for manufacturing sanitizing products, and more particularly relates to surface sanitizing dry powders comprising liquid antibacterial agents and methods for manufacturing the same.

### BACKGROUND OF THE INVENTION

Human health is impacted by a variety of microbes encountered on a daily basis. In particular, contact with various microbes in the environment can lead to an illness, possibly severe, in mammals. For example, microbial contamination can lead to a variety of illnesses, including, but not limited to, food poisoning, streptococcal infection, staphylococcus infection, gastrointestinal disease from escherichia coli, salmonella, shigella, flu and cold from influenza and rhinovirus, stomach flu from norovirus and rotavirus, and the like.

Antibacterial cleansing compositions, which typically are used to cleanse the skin and to destroy bacteria present on the skin, especially the hands, arms, and face of the user, are well-known commercial products. Antibacterial compositions are used, for example, in the health care industry, food service industry, meat processing industry, and in the private sector by individual consumers. The widespread use of antibacterial compositions indicates the importance consumers place on controlling bacteria populations on skin. The paradigm for anti-bacterial compositions is to provide a substantial and broad spectrum reduction in bacterial populations quickly and without adverse side effects associated with toxicity and skin irritation.

One class of antibacterial personal care compositions is hand sanitizers. A hand sanitizer is applied to, and rubbed into, the hands and fingers, and the composition is allowed to evaporate from the skin. However, conventional hand sanitizers are generally low-viscosity fluids. As a result, they tend to run off the hands when applied thereto, can spill from their container, can be sticky and, thus, can be messy for consumers. In addition, they tend to evaporate, whether in liquid form or when in the form of liquid impregnated onto paper or cloth hand wipes.

Accordingly, it is desirable to provide surface and skin sanitizers formed of a plurality of flowable dry particles comprising liquid antibacterial agents therein. In addition, it is desirable provide to methods for manufacturing surface and skin sanitizers formed of a plurality of flowable dry particles comprising liquid antibacterial agents therein. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Skin and surface sanitizers and methods for forming skin and surface sanitizers are provided. In accordance with an exemplary embodiment, a surface sanitizer is formed of a plurality of dry particles. Each dry particle comprises a liquid comprising an antibacterial agent and a dry particulates coating surrounding the liquid. The liquid is present in an amount of from about 10 to about 90 wt. % of each dry particle. The surface sanitizer has a germ kill effectiveness of at least 50%.

In accordance with another exemplary embodiment, a surface sanitizer is formed of a plurality of dry particles. Each dry particle comprises an internal liquid phase with antibacterial properties and a dry particulates coating adsorbed upon a surface of the internal liquid phase. The surface sanitizer is dry and is configured to become a liquid upon application of a shear force.

In accordance with a further exemplary embodiment, a method for forming a surface sanitizer is provided. The method comprises contacting a liquid comprising an antibacterial agent with dry particulates. The liquid and the dry particulates are contacted so as to cause the liquid to adsorb the dry particulates such that flowable dry particles are formed. The dry particles comprise the liquid coated with the dry particulates. The dry particles comprise the liquid in an amount of from about 10 to about 90 wt. % of the surface sanitizer.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The various embodiments of the skin and surface sanitizers (hereinafter referred to collectively as surface sanitizers) contemplated herein are directed to flowable dry powders. The dry powders consist of a plurality of dry particles, beads or spheres (herein “particles”), each formed of a liquid droplet that comprises an antibacterial agent and a dry particulate coating surrounding the liquid. The surface sanitizer exhibits a germ kill effectiveness of at least 50%. To reduce a bacterium population from a surface, such as skin, the dry powder is deposited on the surface where it is dry to the touch. The surface sanitizer becomes a liquid, and the antibacterial agent is distributed to the surface, upon application of a shear force such as by wiping, rubbing, etc. the surface sanitizer onto the surface. Because the surface sanitizer is at first dry to the touch, it does not run from the surface upon application, is not sticky, and is not messy or inconvenient for the consumer.

In an exemplary embodiment, the dry particles of the surface sanitizer each comprise a liquid present in an amount of about 10 to about 90 weight percent (wt. %) of the surface sanitizer. Due, at least in part, to the presence of the antibacterial agent, the surface sanitizer has a germ kill effectiveness of at least 50%. As used herein the term “germ kill effectiveness” is measured using the time kill method, whereby the survival of challenged organisms exposed to an antibacterial test composition is determined as a function of time. In this test, a diluted aliquot of the composition is brought into contact with a known population of test bacteria for a specified time period at a specified temperature. The test composition is neutralized at the end of the time period, which arrests the antibacterial activity of the composition. The percent or, alternatively, log reduction from the original bacteria population is calculated. In general, the time kill method is known to those skilled in the art. In a preferred embodiment, the surface sanitizer has a germ kill effectiveness of 90%. In a more preferred embodiment, the surface sanitizer has a germ kill effectiveness of 99.0 to 99.999%.

The liquid may be made up entirely of the antibacterial agent, or the antibacterial agent may make up only a portion of the liquid phase. In one exemplary embodiment, the antibacterial agent comprises a disinfecting alcohol. As defined herein, the term “disinfecting alcohol” is a water-soluble alcohol containing one to six carbon atoms. Disinfecting alcohols include, but are not limited to, methanol, ethanol, propanol, and isopropyl alcohol. The particles of the surface sanitizers contemplated herein comprise enough disinfecting alcohol to sanitize the surface to which it is applied. Accordingly, in an exemplary embodiment, the surface sanitizers contemplated herein comprise the disinfecting alcohol in an amount of at least 10% volume of alcohol/volume of the total formula (vol./vol.), preferably in an amount of 10 to about 90% vol./vol. In another exemplary embodiment, the antibacterial agent comprises positively-charged quaternary compounds, such as, for example, benzalkonium chloride (BAC), benzethonium chloride (BZT), cationic phospholipids and/or other known compounds with antibacterial properties. Preferably, the BAC is present in an amount of about 0.1 to about 0.5 wt. % of the surface sanitizer. In yet another exemplary embodiment, the antibacterial agent comprises a combination of BAC and disinfecting alcohol, such as, for example, BAC in an amount of from about 0.1 to about 0.5 wt. % of the surface sanitizer and disinfecting alcohol in an amount of less than 60% vol./vol. of the surface sanitizer. In addition to the antibacterial agent, the liquid may comprise other ingredients that have a primary or secondary antibacterial function, such as, for example, 2-methyl 1,3 propanediol, which is a mild antimicrobial but is primarily a humectant/moisturizer.

The liquid of the surface sanitizers contemplated herein also may comprise a carrier. Examples of suitable carriers include, but are not limited to, propylene glycol, dipropylene glycol, and water. In a preferred embodiment, the carrier comprises water.

In another exemplary embodiment, the liquid of the surface sanitizers contemplated herein also contains functional additives well known to persons skilled in the art. The functional additives are present in a sufficient amount to perform their intended function and not adversely affect the antibacterial efficacy of the composition. Functional additives are present, individually or collectively, from 0% to about 50%, by weight of the skin sanitizer.

Classes of functional additives include, but are not limited to, hydrotropes, polyhydric solvents, gelling agents, dyes, fragrances, pH adjusters, thickeners, viscosity modifiers, chelating agents, skin conditioners, humectants, emollients, preservatives, buffering agents, antioxidants, chelating agents, opacifiers, and similar classes of optional ingredients known to persons skilled in the art.

A hydrotrope is a compound that has an ability to enhance the water solubility of other compounds. A hydrotrope lacks surfactant properties, and typically is a short-chain alkyl aryl sulfonate. Specific examples of hydrotropes include, but are not limited to, sodium cumene sulfonate, ammonium cumene sulfonate, ammonium xylene sulfonate, potassium toluene sulfonate, sodium toluene sulfonate, sodium xylene sulfonate, toluene sulfonic acid, and xylene sulfonic acid. Other useful hydrotropes include sodium polynaphthalene sulfonate, sodium polystyrene sulfonate, sodium methyl naphthalene sulfonate, sodium camphor sulfonate, and disodium succinate. A hydrotrope, if present at all, is present in an amount of about 0.1% to about 30%, and preferably about 1% to about 20%, by weight of the composition. To achieve the full advantage of the present invention, a composition can contain about 2% to about 15%, by weight, of a hydrotrope.

The term “polyhydric solvent” as used herein is a water-soluble organic compound containing two to six, and typically two or three, hydroxyl groups. The term “water-soluble” means that the polyhydric solvent has a water solubility of at least 0.1 g of polyhydric solvent per 100 g of water at 25° C. There is no upper limit to the water solubility of the polyhydric solvent, e.g., the polyhydric solvent and water can be soluble in all proportions. The term polyhydric solvent, therefore, encompasses water-soluble diols, triols, and polyols. Specific examples of hydric solvents include, but are not limited to, ethylene glycol, propylene glycol, glycerol, diethylene glycol, dipropylene glycol, tripropylene glycol, hexylene glycol, butylene glycol, 1,2,6-hexanetriol, sorbitol, PEG-4, and similar polyhydroxy compounds. A polyhydric solvent, if present at all, is present in an amount of about 0.1% to about 10%, and preferably about 0.2% to about 5%, by weight of the liquid. More preferably, the polyhydric solvent is present in an amount of about 0.5% to about 1% by weight of the liquid. In contrast to a disinfecting alcohol, a polyhydric solvent contributes minimally, if at all, to the antibacterial efficacy of the present composition.

Other specific classes of optional ingredients include inorganic phosphates, sulfates, and carbonates as buffering agents; EDTA and phosphates as chelating agents; and acids and bases as pH adjusters. Examples of preferred classes of optional basic pH adjusters are ammonia; mono-, di-, and tri-alkyl amines; mono-, di-, and tri-alkanolamines; alkali metal and alkaline earth metal hydroxides; and mixtures thereof. However, the identity of the basic pH adjuster is not limited, and any basic pH adjuster known in the art can be used. Specific, nonlimiting examples of basic pH adjusters are ammonia; sodium, potassium, and lithium hydroxide; monoethanolamine; triethylamine; isopropanolamine; diethanolamine; and triethanolamine. Examples of preferred classes of optional acidic pH adjusters are the mineral acids. Nonlimiting examples of mineral acids are hydrochloric acid, nitric acid, phosphoric acid, and sulfuric acid. The identity of the acidic pH adjuster is not limited, and any acidic pH adjuster known in the art, alone or in combination, can be used. An optional alkanolamide to provide composition thickening can be, but is not limited to, cocamide MEA, cocamide DEA, soyamide DEA, lauramide DEA, oleamide MIPA, stearamide MEA, myristamide MEA, lauramide MEA, capramide DEA, ricinoleamide DEA, myristamide DEA, stearamide DEA, oleylamide DEA, tallowamide DEA, lauramide MIPA, tallowamide MEA, isostearamide DEA, isostearamide MEA, and mixtures thereof. Alkanolamides are noncleansing surfactants and are added, if at all, in small amounts to thicken the composition.

The dry particles of the surface sanitizer also comprise a dry particulates coating that surrounds the liquid. The dry particulates coating can be formed of any dry particulates that are not wetted by the liquid and thus are adsorbed or “float” on the liquid surface. If, however, liquid droplets are produced in the presence of the dry particulates, such as when a shear force is applied during rubbing or wiping of the dry particles, these dry particles do not coalesce again. The dry particulates can be discrete particulates that coat the surface of the liquid or can be bonded to each other, such as in the case of crosspolymers, to encapsulate or form a “shell” around the liquid. The dry particulates coating is stable at temperatures up to 40° C. so as to be stable under heat stressed as well as typical storage conditions. Depending on the liquid of the dry particles, the dry particulates may also be charged, such as when the liquid is a highly charged BAC. The pH, particulates' size, the particulates' surface morphology, and the like may also be selected so as to determine the phase of the dry particles, i.e., soufflé, crème, or powder, for a desired application. Examples of suitable dry particulates include particulates of silica, talc, starches (i.e. corn starch, tapioca starch, potato starch, and the like), crosspolymers, and the like.

In accordance with an exemplary embodiment, a method for forming a surface sanitizer contemplated herein comprises mixing a liquid with dry particulates. The liquid may comprise any of the ingredients set forth herein, including the antibacterial agents described above, and the dry particulates may comprise any of the dry particulates described above. The liquid may be added to the dry particulates in bulk or the liquid and/or the dry particulates may be separated into ingredients or portions of ingredients and may be combined according to ingredients or portions. Preferably, the mixing is high speed mixing performed at speeds of about 1200 revolutions per minute (rpm) to about 30,000 rpm, more preferably about 1500 rpm, although other forms of mixing such as high shear mixing, stirring, agitation, blending, spray drying, or any combination thereof can be used.

The following are exemplary embodiments of surface sanitizers contemplated herein, with each of the components set forth in weight percent of the surface sanitizers. The examples are provided for illustration purposes only and are not meant to limit the various embodiments of the surface sanitizer in any way.

### Example 1

| Ingredient | Wt. % |
|---|---|
| Phase A (powder phase) | |
| Guar Hydroxypropyltrimonium Chloride | 4.80 |
| Mica/triethoxycaprylylsilane | 2.40 |
| Talc/triethoxycaprylylsilane | 3.80 |
| Covafluid FS | 1.00 |
| PW Covasil S1 | 4.30 |
| Phase B (powder phase) | |
| Covabead LH 170 | 2.40 |
| Vinyl dimethicone/methicone | 0.74 |
| silsesquioxane crosspolymer | |
| Phase C (liquid phase) | |
| Pure Water | 1.00 |
| Benzalkonium chloride | 0.26 |
| 2-methyl 1,3 propanediol | 0.30 |
| Phase D (liquid phase) | |
| Pure Water | 77.00 |
| Fucasorb | 2.00 |
| Triethanolamine | q.s. pH = 8 |
| Total | 100.00, |

where Covafluid FS is sodium stearyl fumerate, PW Covasil S1 is titanium dioxide/trimethoxycaprylylsilane, Covabead LH 170 is polymethylmethacrylate crosspolymer, and Fucasorb is algae extract/sorbitol, all available from Sensient Cosmetic Technologies of South Plainfield, N.J.

The surface sanitizer of Example 1 was prepared by mixing all of the ingredients of phase A in an Osterizer™ blender for 30 seconds. All of the ingredients of Phase B were combined, all of the ingredients of phase C were combined, and Phase C was mixed into Phase B. The ingredients of Phase A were combined and then were added to the mixture. The powder was slowly mixed. The propeller blade of the blender was placed just above the powder line of the mixture and Phase D was added. The entire mixture was mixed at 1500 rpm until the powder was engulfed and started to absorb the water. The mixing was continued 1500 rpm until a smaller, even portion of the powder mixture was achieved. The mixing was stopped when the mixture started to ball and cream. A short burst of high speed mixing at 1500 rpm was continued until a fine even powder was obtained.

### Example 2

| Ingredient | Wt. % |
|---|---|
| Polydimethylsiloxane | 1.75 |
| Benzalkonium chloride 50% USP | 0.26 |
| Glycerin USP | 2.63 |
| Polyethylene glycol | 4.38 |
| Dimethicone | 3.50 |
| Water | 75.16 |
| Silica Silyate | 5.32 |
| Hydrated Silica | 7.00 |
| Total | 100.00, |

The surface sanitizer of Example 2 was prepared by mixing 1.5 wt. % BAC, 10 wt. % polydimethylsiloxane, 15 wt. % glycerine, 25 wt. % polyethylene glycol, 20 wt. % dimethicone, and 28.5 wt. % water together to form a homogeneous emollient mixture. 70 wt. % of the emollient mixture was then combined with 28 wt. % hydrate silica until a powder was formed. A 1 millimeter (mm) sieve was used during mixing to ensure homogeneous distribution. The powder was mixed with 2 wt. % silica silyate to form an emollient carrier and the carrier was subjected to a 1 mm sieve again to ensure even blending. A dry water was prepared by mixing 93 wt. % water and 7 wt. % silica silyate in a high speed blender for 45 seconds to 1 min. The blender was tilted from side to side during blending to ensure even blending. The emollient carrier was then added to the dry water while the dry water was mixing to prevent the dry water from breaking and turning into a cream to early.

### Example 3

| Phase A (powder phase) | |
|---|---|
| Guar Hydroxypropyltrimonium Chloride | 4.80 |
| Mica/triethoxycaprylylsilane | 2.40 |
| Talc/triethoxycaprylylsilane | 3.80 |
| Covafluid FS | 1.00 |
| PW Covasil S1 | 4.30 |
| Phase B (powder phase) | |
| Covabead LH 170 | 2.40 |
| Vinyl dimethicone/methicone | 0.74 |
| silsesquioxane crosspolymer | |
| Phase C (liquid phase) | |
| Pure Water | 0.63 |
| Ethyl Alcohol | 63.00 |
| 2-methyl 1,3 propanediol | 0.30 |
| Phase D (liquid phase) | |
| Pure Water | 14.00 |
| Fucasorb | 2.00 |
| Triethanolamine | q.s. pH = 8 |
| Total | 100.00, |

The surface sanitizer of Example 3 was prepared by mixing all of the ingredients of phase A in an Osterizer™ blender for 30 seconds. All of the ingredients of Phase B were combined and all of the ingredients of phase C were mixed into Phase B using a propeller blade until homogeneity was achieved. The ingredients of Phase A were combined and then were added to the mixture. The powder was slowly mixed. The propeller blade of the blender was placed just above the powder line of the mixture and Phase D was added. The entire mixture was mixed at 1500 rpm until the powder was engulfed and started to absorb the water. The mixing was continued 1500 rpm until a smaller, even portion of the powder mixture was achieved. The mixing was stopped when the mixture started to ball and cream. A short burst of high speed mixing at 1500 rpm was continued until a fine even powder was obtained.

Accordingly, skin and surface sanitizers in the form of flowable dry powders have been provided. The dry powders consist of a plurality of dry particles, each formed of a liquid that comprises an antibacterial agent and a dry particulates coating surrounding the liquid. The surface sanitizer exhibits a germ kill effectiveness of at least 50%. To reduce a bacterium population from a surface, such as skin, the dry powder is deposited on the surface where it is dry to the touch. The surface sanitizer becomes a liquid, and the antibacterial agent is distributed to the surface, upon application of a shear force such as by wiping, rubbing, etc. the surface sanitizer onto the surface.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A surface sanitizer formed of a plurality of dry particles, each dry particle comprising:
a liquid comprising an antibacterial agent; and
a dry particulates coating surrounding the liquid,
wherein the liquid is present in an amount of from about 10 to about 90 wt. % of each dry particle and wherein the surface sanitizer has a germ kill effectiveness of at least 50%.

2. The surface sanitizer of claim 1, wherein the antibacterial agent comprises a disinfecting alcohol.

3. The surface sanitizer of claim 2, wherein the disinfecting alcohol is methanol, ethanol, propanol, and isopropyl alcohol.

4. The surface sanitizer of claim 2, wherein the disinfecting alcohol is present in an amount of at least about 10% volume of alcohol/volume of the total surface sanitizer.

5. The surface sanitizer of claim 2, wherein the disinfecting alcohol is present in an amount of at least about 10 to about 90% volume of alcohol/volume of the total surface sanitizer.

6. The surface sanitizer of claim 1, wherein the antibacterial agent comprises benzalkonium chloride.

7. The surface sanitizer of claim 6, wherein the benzalkonium chloride is present in an amount of about 0.1 to about 0.5 wt. % of the surface sanitizer.

8. The surface sanitizer of claim 1, wherein the dry particulates coating comprise a crosspolymer.

9. The surface sanitizer of claim 1, wherein the dry particulates coating comprise a material selected from the group consisting of silica, talc, and starch.

10. The surface sanitizer of claim 1, wherein the surface sanitizer has a germ kill effectiveness of at least 90%.

11. A surface sanitizer formed of a plurality of dry particles, each dry particle comprising:
an internal liquid phase with antibacterial properties; and
a dry particulates coating adsorbed upon a surface of the internal liquid phase,
wherein the surface sanitizer is dry and is configured to become a liquid upon application of a shear force.

12. The surface sanitizer of claim 11, wherein the internal liquid phase comprises an antibacterial agent having a germ kill effectiveness of at least 50%.

13. The surface sanitizer of claim 12, wherein the antibacterial agent comprises a disinfecting alcohol.

14. The surface sanitizer of claim 13, wherein the disinfecting alcohol is methanol, ethanol, propanol, and isopropyl alcohol.

15. The surface sanitizer of claim 13, wherein the disinfecting alcohol is present in an amount of at least about 10% volume of alcohol/volume of the total surface sanitizer.

16. The surface sanitizer of claim 15, wherein the disinfecting alcohol is present in an amount of at least about 10 to about 90% volume of alcohol/volume of the total surface sanitizer.

17. The surface sanitizer of claim 12, wherein the antibacterial agent comprises benzalkonium chloride.

18. The surface sanitizer of claim 17, wherein the benzalkonium chloride is present in an amount of about 0.1 to about 0.5 wt. % of the surface sanitizer.

19. The surface sanitizer of claim 11, wherein the dry particulates coating comprise a crosspolymer.

20. The surface sanitizer of claim 1, wherein the dry particulates coating comprises material selected from the group consisting of silica, talc, and starch.

21. A method for forming a surface sanitizer, the method comprising the steps of:
contacting a liquid comprising an antibacterial agent with dry particulates so as to cause the liquid to adsorb the dry particulates such that flowable dry particles comprising the liquid, in an amount of from about 10 to about 90 wt. % of the surface sanitizer, coated with the dry particulates are formed.

22. The method of claim 21, wherein the step of contacting comprises contacting the liquid comprising a disinfecting alcohol with the dry particulates.

23. The method of claim 22, wherein the step of contacting comprises contacting the liquid comprising methanol, ethanol, propanol, or isopropyl alcohol with the dry particulates.

24. The method of claim 22, wherein the step of contacting comprises contacting the liquid comprising the disinfecting alcohol present in an amount of at least about 10% volume of alcohol/volume of the total surface sanitizer with the dry particulates

25. The method of claim 22, wherein the step of contacting comprises contacting the liquid comprising the disinfecting alcohol present in an amount of at least about 10 to about 90% volume of alcohol/volume of the total surface sanitizer with the dry particulates.

26. The method of claim 21, wherein the step of contacting comprises contacting the liquid comprising benzalkonium chloride with the dry particulates.

27. The method of claim 26, wherein the step of contacting comprises contacting the liquid comprising the benzalkonium chloride present in an amount of about 0.1 to about 0.5 wt. % of the surface sanitizer with the dry particles.

28. The method of claim 21, wherein the step of contacting comprises contacting the liquid with the dry particulates comprising a crosspolymer.

29. The method of claim 21, wherein the step of contacting comprises contacting the liquid with the dry particulates comprising silica, talc, or starch.
